(19) United States
(12) Patent Application Publication
(10) Pub. No.: US 2015/0346828 A1
(43) Pub. Date: Dec. 3, 2015

(54) GESTURE CONTROL METHOD, GESTURE CONTROL MODULE, AND WEARABLE DEVICE HAVING THE SAME

(71) Applicant: PEGATRON CORPORATION, Taipei City (TW)

(72) Inventors: Yu-Chang CHEN, Taipei City (TW); Wen-Ham CHIANG, Taipei City (TW)

(21) Appl. No.: 14/720,314

(22) Filed: May 22, 2015

(30) Foreign Application Priority Data
May 28, 2014 (TW) 103118706

(51) Int. Cl. G06F 3/01; G06K 9/00

(52) U.S. Cl. CPC G06F 3/017; G06K 9/00355

(57) ABSTRACT

A gesture control method, a gesture control module, and a wearable device having the same. The gesture control method includes the following steps: executing a setting procedure, including: capturing a hand image; identifying a plurality of identification points from the hand image; recording at least one relative distance between each identification point and other identification points; and executing a controlling procedure, including: determining whether a quantity of the identification points or their relative distances have changed; and if yes, generating a corresponding command according to changes in the quantity of the identification points or their relative distances.

### BACKGROUND OF THE INVENTION

1. Field of the Invention

The present application relates to a gesture control method, a gesture control module, and a wearable device having the same; more particularly, the present application relates a gesture control method, a gesture control module, and a wearable device capable of providing the user a precise control experience.

2. Description of the Related Art

With advancements in technology, the control methods of electronic devices have become very diverse. In the prior art, a variety of wearable devices with a function of an electronic device or for matching to an electronic device, such as glasses, watches or necklaces, have been developed. In general, control of the wearable device in the prior art is usually effected with voice control, physical keys, or a virtual touch screen. However, each control mode has problems. The voice control mode may entail a high error rate, such that the wearable device will generate incorrect control commands. Although physical keys or virtual touch screens are effective modes for controlling a wearable device directly and reducing the rate of errors, the limited surface area of a wearable device limits the quantity of buttons that can be disposed thereupon. Therefore, the uses of a wearable device will be limited.

Therefore, it is necessary to invent a new a gesture control method, a gesture control module, and a wearable device having the same to solve the problem of the prior art.

### SUMMARY OF THE INVENTION

It is an object of the present application to provide a gesture control module that provides the user a precise control experience.

It is another object of the present application to provide a wearable device having a gesture control module.

It is still another object of the present application to provide a gesture control method.

To achieve the abovementioned objects, the gesture control module is used in the wearable device. The gesture control module comprises a capture module, used for capturing a hand image; an identification module, electrically connected to the capture module, for identifying a plurality of identification points from the hand and recording at least one relative distance between each identification point and other identification points; a database, electrically connected to the identification module and having a correspondence table for storing a plurality of hand image parameters and a plurality of corresponding commands, wherein the plurality of hand image parameters comprise a change in a quantity of the identification points and their relative distances; and a main control module, electrically connected to the identification module, for determining whether the quantity of the identification points or their relative distances have changed, and if the quantity of the identification points or their relative distances have changed, the main control module generates a corresponding command according to the changes in the quantity of the identification points or their relative distances according to the correspondence table.

The wearable device of the present application comprises a gesture control module, comprising: a capture module, used for capturing a hand image; an identification module, electrically connected to the capture module, for identifying a plurality of identification points from the hand and recording at least one relative distance between each identification point and other identification points; a database, electrically connected to the identification module and having a correspondence table for storing a plurality of hand image parameters and a plurality of corresponding commands, wherein the plurality of hand image parameters comprise a change in a quantity of the identification points and their relative distances; and a main control module, electrically connected to the identification module for determining whether the quantity of the identification points or their relative distances have changed, and if the quantity of the identification points or their relative distances have changed, the main control module generates a corresponding command according to the changes in the quantity of the identification points or their relative distances according to a search of the correspondence table; and a controlled module, electrically connected to the main control module, for executing a corresponding action according to the corresponding command.

The gesture control method of the present application comprises the following steps: executing a setting procedure, comprising: capturing a hand image; identifying a plurality of identification points from the hand image; and recording at least one relative distance between each identification point and other identification points; and executing a controlling procedure, comprising: determining whether a quantity of the identification points or their relative distances have changed; and if yes, generating a corresponding command according to the changes in the quantity of the identification points or their relative distances.

### BRIEF DESCRIPTION OF THE DRAWINGS

These and other objects and advantages of the present application will become apparent from the following description of the accompanying drawings, which disclose several embodiments of the present application. It is to be understood that the drawings are to be used for purposes of illustration only, and not as a definition of the invention.

In the drawings, wherein similar reference numerals denote similar elements throughout the several views:

FIG. 1 is a schematic drawing of the gesture control module of the present application.

FIG. 2 is a schematic drawing of the hand image of the present application.

FIG. 3 is a flowchart of the gesture control method of the present application.

FIG. 4A is a flowchart of the gesture control method of the present application according to the first embodiment.

FIG. 4B is a schematic drawing of the hand image of the first embodiment of the present application according to FIG. 4A.

FIG. 5A is a flowchart of the gesture control method of the present application according to the second embodiment.

FIG. 5B is a schematic drawing of the hand image of the second embodiment of the present application according to FIG. 5A.

FIG. 6A is a flowchart of the gesture control method of the present application according to the third embodiment. FIG. 6B is a schematic drawing of the hand image of the third embodiment of the present application according to FIG. 6A.

FIG. 7A is a flowchart of the gesture control method of the present application according to the fourth embodiment.

FIG. 7B is a schematic drawing of the hand image of the fourth embodiment of the present application according to FIG. 7A.

FIG. 8A is a flowchart of the gesture control method of the present application according to the fifth embodiment.

FIG. 8B is a schematic drawing of the hand image of the fifth embodiment of the present application according to FIG. 8A.

FIG. 9A is a flowchart of the gesture control method of the present application according to the sixth embodiment.

FIG. 9B is a schematic drawing of the hand image of the fifth embodiment of the present application according to FIG. 9A.

### DETAILED DESCRIPTION OF THE PREFERRED EMBODIMENT

Reference will now be made in detail to exemplary embodiments of the present application, examples of which are illustrated in the accompanying drawings, wherein like reference numerals refer to the like elements throughout. Exemplary embodiments are described below to explain the present application by referring to the figures.

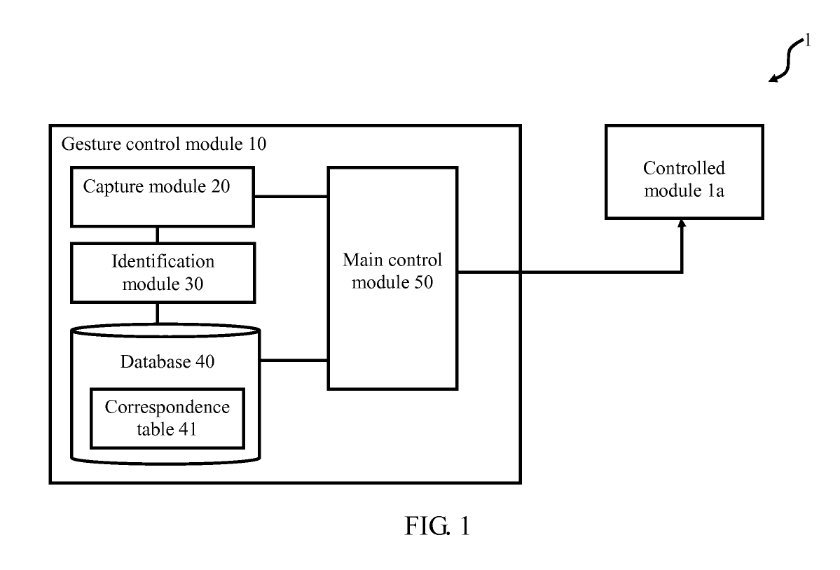

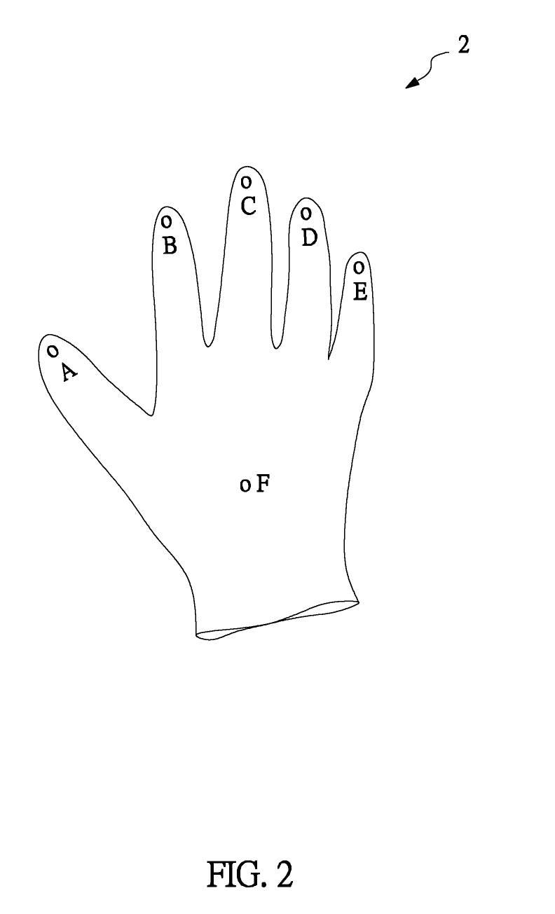

FIG. 1 is a schematic drawing of the gesture control module of the present application.

The gesture control module 10 of the present application is used in a wearable device 1. The wearable device 1 may be, but is not limited to, a watch, a necklace, or a pair of glasses. The gesture control module 10 comprises a capture module 20, an identification module 30, a database 40, and a main control module 50. The capture module 20 is a depth sensor used for capturing a hand image 2. Shown in FIG. 2 is a schematic drawing of the hand image of the present application. When setting the gesture control module 10, the user operates the capture module 20 to capture a hand image of the user and generate a default hand image 2. The hand image 2 shown in FIG. 2 of the present application is an image of the right hand of the user, but the image is not limited to that hand. The capture module 20 may also capture an image of the left hand or an image of both hands of the user as a basis for identification.

The identification module 30 is constructed of hardware, firmware with hardware, or software with hardware. The identification module 30 is electrically connected to the capture module 20 for identifying a plurality of identification points in the hand image 2 and recording at least one relative distance between each identification point and other identification points. In the present embodiment, the identification module 30 may identify five fingertips and a palm center point as six identification points. For example, the identification module 30 may identify the five fingertips as a first identification point A, a second identification point B, a third identification point C, a fourth identification point D, and a fifth identification point E sequentially, and identify the palm center point as a sixth identification point F, but the present application is not limited to this setting. When the identification module 30 identifies the abovementioned first identification point A to the sixth identification point F, the identification module 30 records the relative distances between each of the identification points.

The database 40 is electrically connected to the identification module 30. The database 40 is a storage medium and is used for storing a correspondence table 41. The correspondence table 41 is used for storing a plurality of hand image parameters and a plurality of corresponding commands, wherein the plurality of hand image parameters comprise a change in a quantity of the identification points and their relative distances. The main control module 50 is electrically connected to the identification module 40. The main control module 50 is constructed of hardware, firmware with hardware, or software with hardware; for example, the main control module 50 may be a microprocessor chip in the gesture control module 10, but the present application is not limited to this design. The main control module 50 is used to determine whether the quantity of the identification points or their relative distances from the hand image 2 is changed according to the comparison between the identified result and the default hand image 2. If the main control module 50 determines that the quantity of the identification points or their relative distances have changed, the main control module 50 generates a corresponding command according to the changes in the quantity of the identification points or their relative distances according to the correspondence table 41.

The wearable device 1 further comprises a controlled module 1a. The controlled module 1a is constructed of hardware, firmware with hardware, or software with hardware. The controlled module 1a may comprise a music play module, a phone dialer module, or a camera module in the wearable device 1. After the main control module 50 generates the corresponding command, the controlled module 1a is used to execute a corresponding action according to the corresponding command.

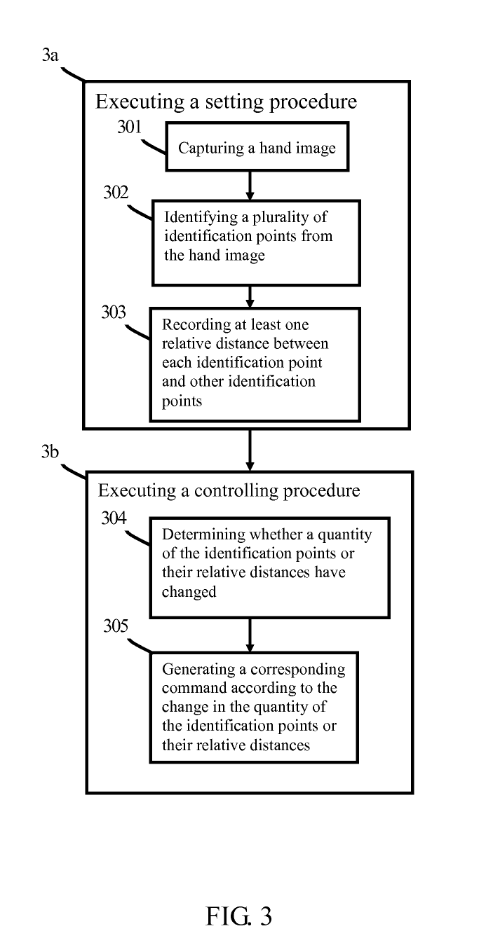

FIG. 3 is a flowchart of the gesture control method of the present application. It should be noted that the wearable device 1 having the gesture control module 10 is used as an example to illustrate the gesture control method of the present application, but the method is not limited to this embodiment.

First, the gesture control method generated by the gesture control module 10 comprises two main steps, step 3a: executing a setting procedure, and step 3b: executing a controlling procedure.

When the gesture control module 10 executes the setting procedure of step 3a, step 301 is executed first: capturing a hand image.

First, the capture module 20 is used to take a photo of the hand of the user to capture a hand image 2.

Step 302 is then executed: identifying a plurality of identification points from the hand image.

Then the identification module 30 identifies a plurality of identification points from the hand image captured by the capture module 20. In the present embodiment, the identification module 30 identifies the five fingertips as a first identification point A, a second identification point B, a third identification point C, a fourth identification point D, and a fifth identification point E sequentially and identifies the palm center point as a sixth identification point F, but the present application is not limited to this embodiment.

Then step 303 is executed: recording at least one relative distance between each identification point and other identification points.

After the identification module 30 identifies the abovementioned first identification point A to the sixth identification point F, the identification module 30 records and stores at least one relative distance between each identification point and other identification points in the database 40 or other storage media, but the present application is not limited to this embodiment.

Thus, the gesture control module 10 is able to determine the quantity of identification points and their relative distances between each of the identification points of the hand image 2 to complete the setting procedure of step 3a.

Then when the gesture control module 10 executes the controlling procedure of step 3b, step 304 is executed: determining whether a quantity of the identification points or their relative distances have changed.

Then the main control module 50 determines whether the hand image 2 is different from the image captured by the capture module 20. The main control module 50 may determine whether the captured hand image and the default hand image 2 are different or not via a search in the database 40. The main control module 50 is used to determine whether the quantity of the identification points or their relative distances have changed to determine if the gesture of the user's hand has changed. It is not necessary to identify the full range of the hand image 2.

If the quantity of the identification points or their relative distances have changed in step 304, step 305 is then executed: generating a corresponding command according to the change in the quantity of the identification points or their relative distances.

Meanwhile, main control module 50 is used to search the correspondence table 41 to generate a corresponding command according to the change in the quantity of the identification points or their relative distances. The corresponding command is used to control the controlled module 1a to execute corresponding actions.

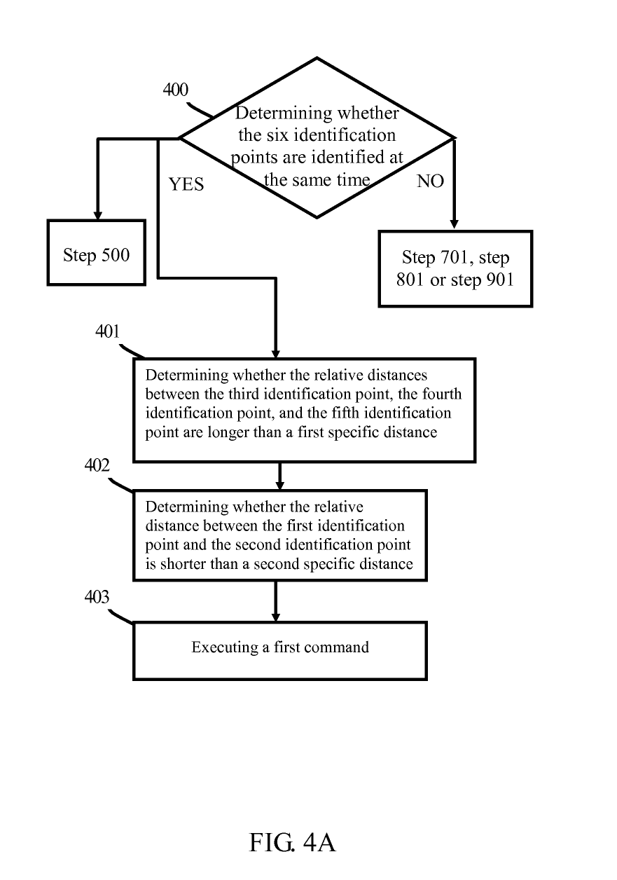

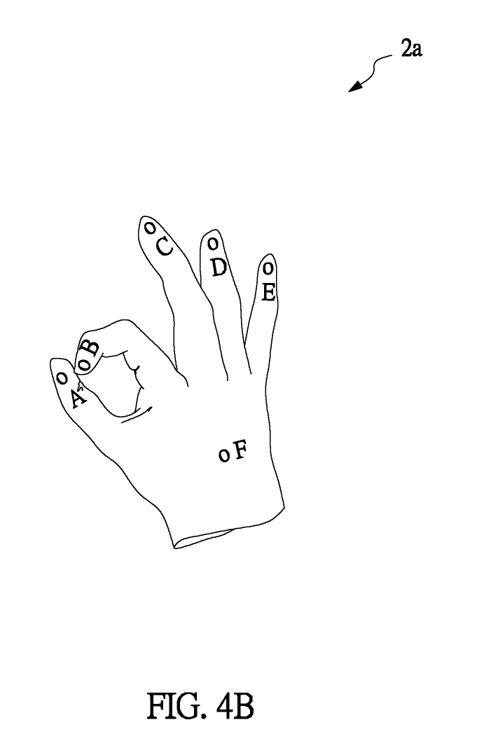

The present application may comprise different embodiments; therefore, the main control module 50 may generate different corresponding commands based on different gestures. Hereinafter, please refer to FIG. 4A and FIG. 4B. FIG. 4A is a flowchart of the gesture control method of the present application according to the first embodiment, and FIG. 4B is a schematic drawing of the hand image of the first embodiment of the present application according to FIG. 4A.

First, step 400 is executed: determining whether the six identification points are identified at the same time.

First, the main control module 50 determines whether the six identification points are identified at the same time from the hand image 2 captured continuously by the capture module 20. If the main control module 50 identifies six identification points from the hand image 2 at the same time, then step 401 or step 500 is executed. However, if the main control module 50 does not identify six identification points from the hand image 2 at the same time, then step 701, step 801, or step 901 is executed. It should be noted that the hand images 2a to 2f below are exemplary embodiments only; the present application is not limited to the abovementioned six gestures.

In the first embodiment of the present application, the hand image 2a captured by the capture module 20 is described as an example first. Therefore, the main control module 50 is able to determine that the hand image 2a has six identification points in step 400.

If the main control module 50 determines that the hand image 2a has six identification points, step 401 is then executed: determining whether the relative distances between the third identification point, the fourth identification point, and the fifth identification point are longer than a first specific distance.

Second, the main control module 50 is used to confirm the relative distances between the third identification point C, the fourth identification point D, and the fifth identification point E from the hand image 2a. If the relative distances between the abovementioned identification points are longer than a first specific distance, it will be determined that the third identification point C, the fourth identification point D, and the fifth identification point E are in an open state.

Step 402 is then executed: determining whether the relative distance between the first identification point and the second identification point is shorter than a second specific distance.

The main control module 50 is used to confirm the relative distance between the first identification point A and the second identification point B from the hand image 2a. If the relative distance between the abovementioned identification points is shorter than a second specific distance, it may be confirmed that the first identification point A and the second identification point B have moved closer to, or are directly touching, each other.

If the above confirmation occurs, then after the main control module 50 executes the abovementioned steps 401 and 402, step 403 is executed: executing a first command.

After the abovementioned steps 401 and 402 are executed, the main control module 50 determines that the hand image 2a is similar to a hand gesture of “OK.” Thus, the correspondence table 41 will then be checked and the controlled module 1a will be requested to execute the first command. In the first present embodiment of the present application, the first command may be a command of “CONFIRM.”

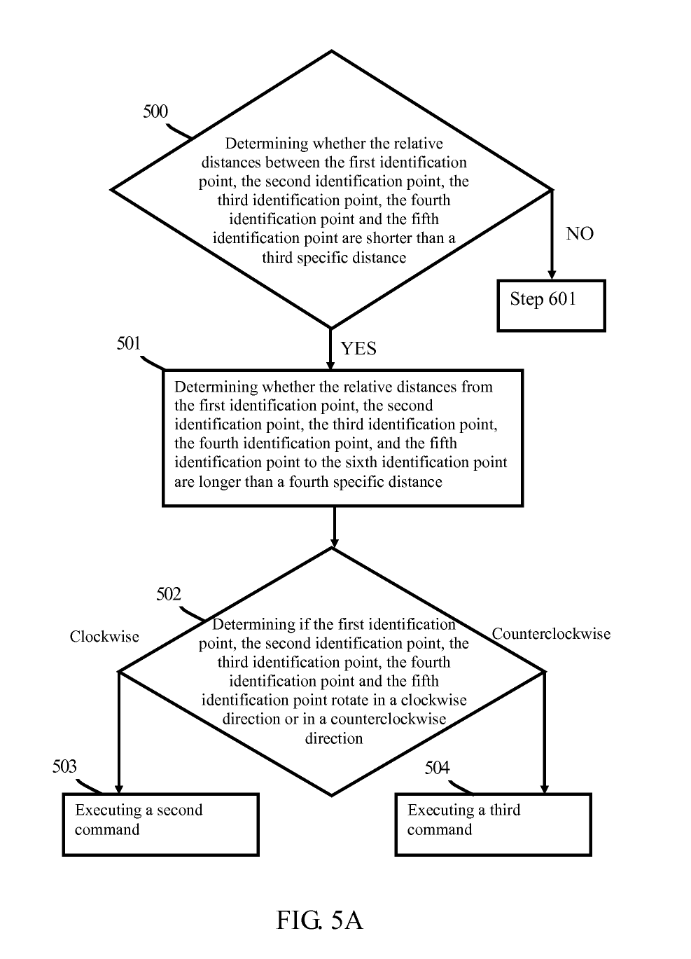

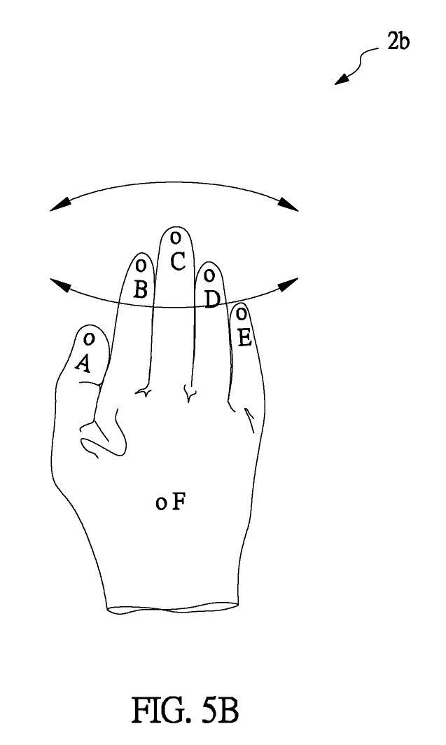

Hereinafter, please refer to FIGS. 5A and 5B. FIG. 5A is a flowchart of the gesture control method of the present application according to the second embodiment. FIG. 5B is a schematic drawing of the hand image of the second embodiment of the present application according to FIG. 5A.

In the second embodiment of the present application, the capture module 20 is used to capture the hand image 2b; then the main control module 50 may determine that the hand image 2a has six identification points in the abovementioned step 400.

Thus, in the second embodiment, step 500 is executed first: determining whether the relative distances between the first identification point, the second identification point, the third identification point, the fourth identification point, and the fifth identification point are shorter than a third specific distance.

The main control module 50 is used to determine whether the relative distances between the first identification point A, the second identification point B, the third identification point C, the fourth identification point D, and the fifth identification point E are shorter than a third specific distance from the hand image 2b. If the relative distances between the first identification point A, the second identification point B, the third identification point C, the fourth identification point D, and the fifth identification point E are shorter than a third specific distance, the main control module 50 determines that the five fingertips from the hand image 2b are close to other fingertips. Oppositely, if the relative distances between the first identification point A, the second identification point B, the third identification point C, the fourth identification point D, and the fifth identification point E are longer than the third specific distance, the main control module 50 executes step 601.

Thus, if the relative distances between the first identification point A, the second identification point B, the third identification point C, the fourth identification point D, and the fifth identification point E are shorter than the third specific distance, step 501 is then executed: determining whether the relative distances from the first identification point, the second identification point, the third identification point, the fourth identification point, and the fifth identification point to the sixth identification point are longer than a fourth specific distance.

Meanwhile, the main control module 50 is used to further determine whether the relative distances from the first identification point, the second identification point, the third identification point, the fourth identification point, and the fifth identification point to the sixth identification point are longer than a fourth specific distance. If the relative distances are longer than a fourth specific distance, the main control module 50 determines that the five fingers from the hand image 2b have been extended.

Step 502 is then executed: determining whether the first identification point, the second identification point, the third identification point, the fourth identification point and the fifth identification point rotate in a clockwise direction or in a counterclockwise direction.

Hereinafter, the main control module 50 determines the rotation direction of each identification point with the hand image 2b captured by the capture module 20. When the first identification point A, the second identification point B, the third identification point C, the fourth identification point D and the fifth identification point E all rotate in a clockwise direction, step 503 is executed: executing a second command.

After the abovementioned step is executed, the main control module 50 identifies the gesture and the direction of the hand image 2b. Thus, the second command is executed to control the controlled module 1a. In the second embodiment of the present application, the controlled module 1a may be a menu control module, and the second command may be a command to switch to the last page.

Finally, when the first identification point A, the second identification point B, the third identification point C, the fourth identification point D and the fifth identification point E all rotate in a counterclockwise direction, step 504 is executed: executing a third command.

When the main control module 50 determines that the first identification point A, the second identification point B, the third identification point C, the fourth identification point D and the fifth identification point E all rotate in a counterclockwise direction, the main control module 50 is used to execute the third command to control the controlled module 1a. In the second embodiment of the present application, the controlled module 1a may be a menu controlled module. The third command may be the opposite of the second command and may be a command to switch to the next page.

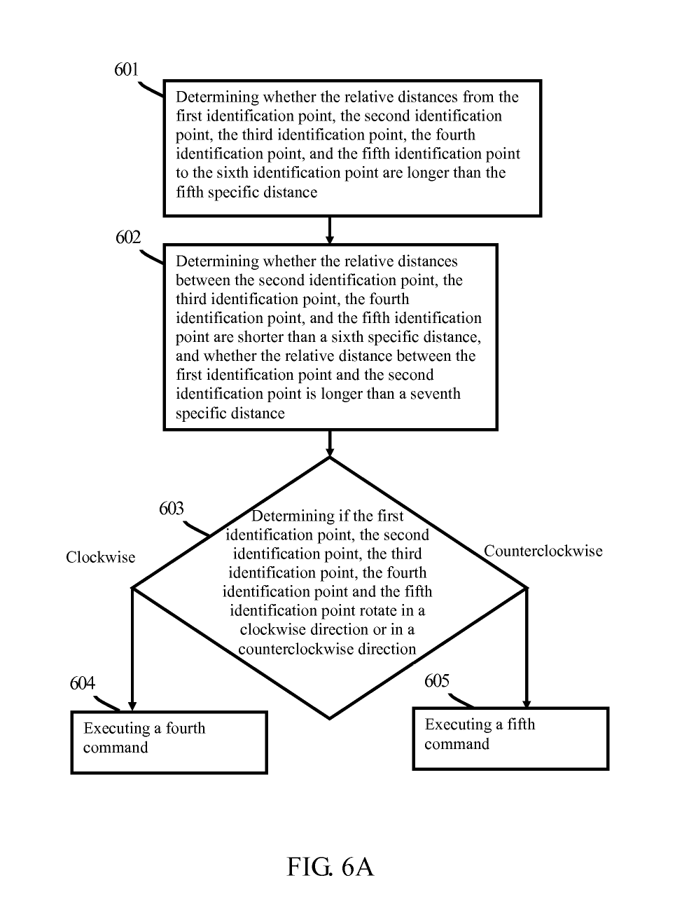

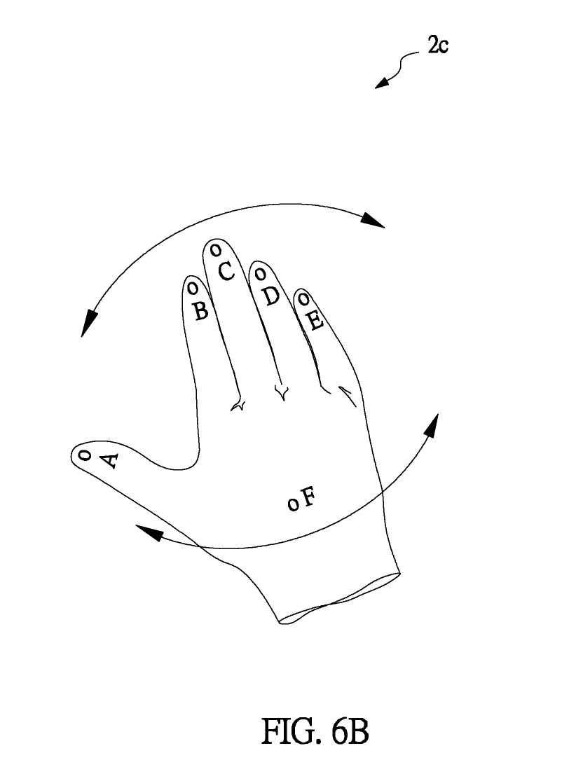

Hereinafter, please refer to FIG. 6A and FIG. 6B. FIG. 6A is a flowchart of the gesture control method of the present application according to a third embodiment. FIG. 6B is a schematic drawing of the hand image of the third embodiment of the present application according to FIG. 6A.

In the third embodiment of the present application, if the main control module 50 determines that the distances between the first identification point A, the second identification point B, the third identification point C, the fourth identification point D and the fifth identification point E from the hand image 2c are longer than the third specific distance, the main control module 50 determines that the five fingertips from the hand image are not close to other fingertips.

Thus, step 601 is then executed: determining whether the relative distances from the first identification point, the second identification point, the third identification point, the fourth identification point, and the fifth identification point to the sixth identification point are longer than a fifth specific distance. When the main control module 50 determines that the distances from the first identification point, the second identification point, the third identification point, the fourth identification point, and the fifth identification point to the sixth identification point are longer than the fifth specific distance, it represents that the fingers are in an extended state.

Step 602 is then executed: determining whether the relative distances between the second identification point, the third identification point, the fourth identification point, and the fifth identification point are shorter than a sixth specific distance; and whether the relative distance between the first identification point and the second identification point is longer than a seventh specific distance.

When the main control module 50 determines that the relative distances between the second identification point, the third identification point, the fourth identification point, and the fifth identification point are shorter than a sixth specific distance, it represents that all fingers from the forefinger to the little finger are close together. Meanwhile, when the main control module 50 determines that the distance between the first identification point A and the second identification point B is longer than the seventh specific distance, it represents that the forefinger and the thumb are separate.

Step 603 is then executed: determining whether the first identification point, the second identification point, the third identification point, the fourth identification point and the fifth identification point rotate in a clockwise direction or in a counterclockwise direction.

The main control module 50 determines the rotation direction of each identification point from the hand image 2c captured by the capture module 20. When the first identification point A, the second identification point B, the third identification point C, the fourth identification point D and the fifth identification point E all rotate in a clockwise direction, then step 604 is executed: executing a fourth command.

After the abovementioned step is executed, the main control module 50 identifies the gesture and the rotation direction of the hand image 2c. Thus, the fourth command is executed to control the controlled module 1a. In the third embodiment of the present application, the controlled module 1a may be a volume control module, and the fourth command may be a command for increasing the volume.

When the first identification point A, the second identification point B, the third identification point C, the fourth identification point D and the fifth identification point E all rotate in a counterclockwise direction, then step 605 is executed: executing a fifth command.

When the first identification point A, the second identification point B, the third identification point C, the fourth identification point D and the fifth identification point E all rotate in a counterclockwise direction, the main control module executes the fifth command to control the controlled module 1a. In the third embodiment of the present application, the controlled module 1a may be a volume control module. The fifth command is opposite to the fourth command and may be a command for decreasing the volume.

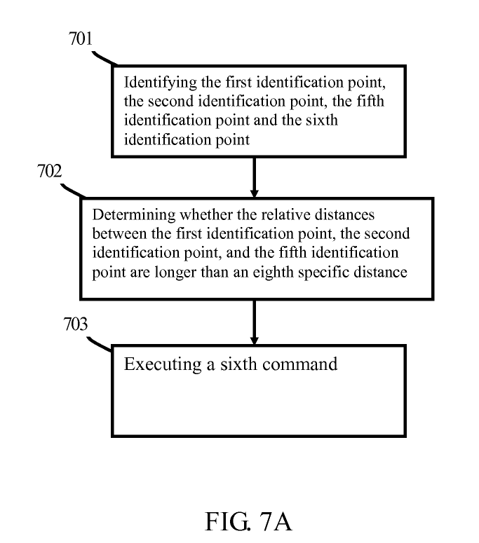

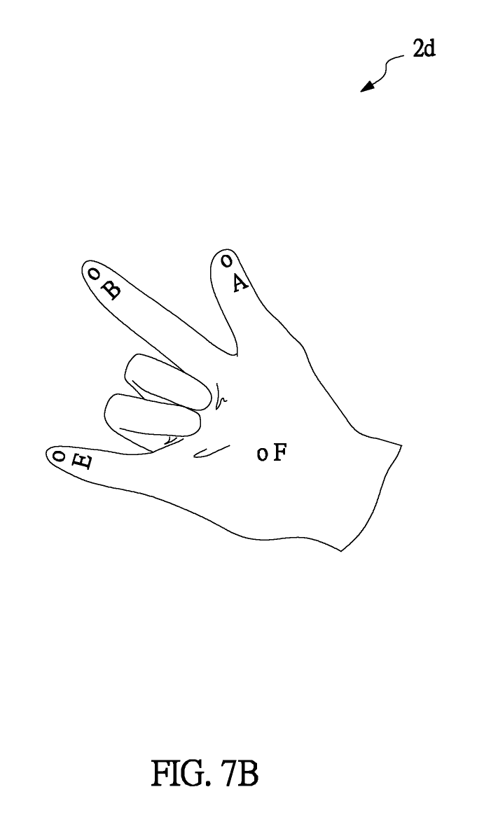

Hereinafter, please refer to FIG. 7A and FIG. 7B. FIG. 7A is a flowchart of the gesture control method of the present application according to a fourth embodiment. FIG. 7B is a schematic drawing of the hand image of the fourth embodiment of the present application according to FIG. 7A.

After step 400 is executed, if the main control module 50 determines that the six identification points are not identified at the same time from the hand image 2 captured continuously by the capture module 20, step 701 is then executed: identifying the first identification point, the second identification point, the fifth identification point and the sixth identification point.

In the fourth embodiment of the present application, if the six identification points are not identified at the same time from the hand image 2d by the main control module, the main control module 50 may identify the first identification point A, the second identification point B, the fifth identification point E and the sixth identification point F from the hand image 2d.

Step 702 is then executed: determining whether the relative distances between the first identification point, the second identification point, and the fifth identification point are longer than an eighth specific distance.

The main control module 50 may determine that the relative distances between the first identification point A, the second identification point B, the fifth identification point E and the sixth identification point F from the hand image 2d are longer than an eighth specific distance. If the answers to the abovementioned steps 701 to 702 are “YES”, step 703 is executed: executing a sixth command.

After the abovementioned steps 701 and 702 are executed, the main control module 50 identifies the gesture of the hand image 2d. Thus, the sixth command is executed to control the controlled module 1a. In the fourth embodiment of the present application, the controlled module 1a may be a music play module, and the sixth command may be a command for playing the music.

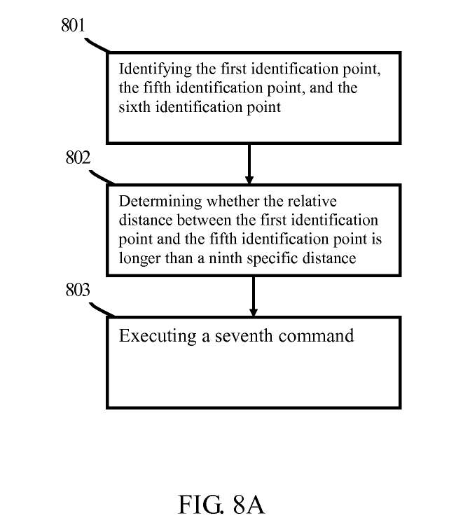

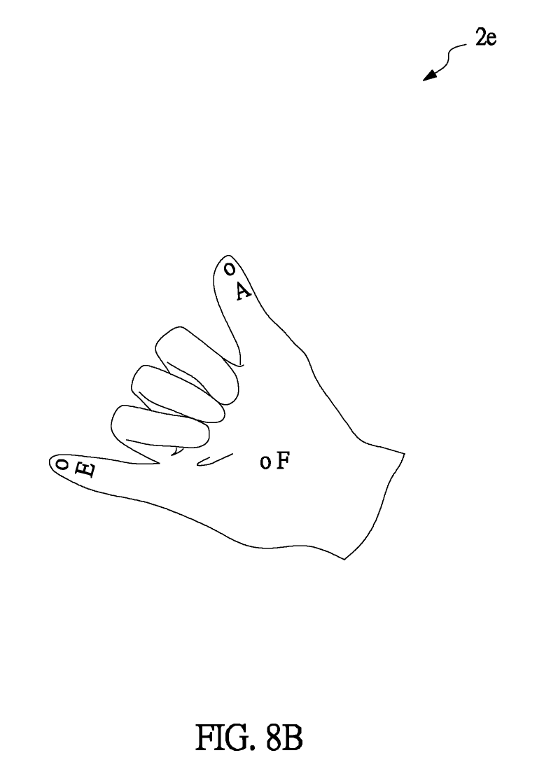

Hereinafter, please refer to FIGS. 8A and 8B. FIG. 8A is a flowchart of the gesture control method of the present application according to the fifth embodiment. FIG. 8B is a schematic drawing of the hand image of the fifth embodiment of the present application according to FIG. 8A.

After step 400 is executed, if the main control module 50 determines that the six identification points are not identified at the same time from the hand image 2 captured continuously by the capture module 20, step 801 may also be then executed: identifying the first identification point, the fifth identification point, and the sixth identification point.

In the fifth embodiment of the present application, if the six identification points are not identified at the same time from the hand image 2 by the main control module 50, the main control module 50 may identify the first identification point A, the fifth identification point E and the sixth identification point F from the hand image 2d.

Step 802 is then executed: determining whether the relative distance between the first identification point and the fifth identification point is longer than a ninth specific distance.

The main control module 50 may determine that the relative distances between the first identification point A, the fifth identification point E and the sixth identification point F from the hand image 2d are longer than a ninth specific distance.

If the answers to the abovementioned steps 801 to 802 are “YES”, step 803 is executed: executing a seventh command.

After the abovementioned steps 801 and 802 are executed, the main control module 50 identifies the gesture of the hand image 2e. Thus, the seventh command is executed to control the controlled module 1a. In the fifth embodiment of the present application, the controlled module 1a may be a communication module, and the seventh command may be a command for phone communication.

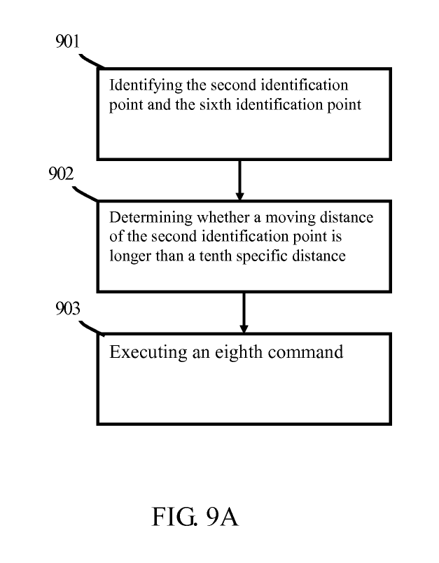

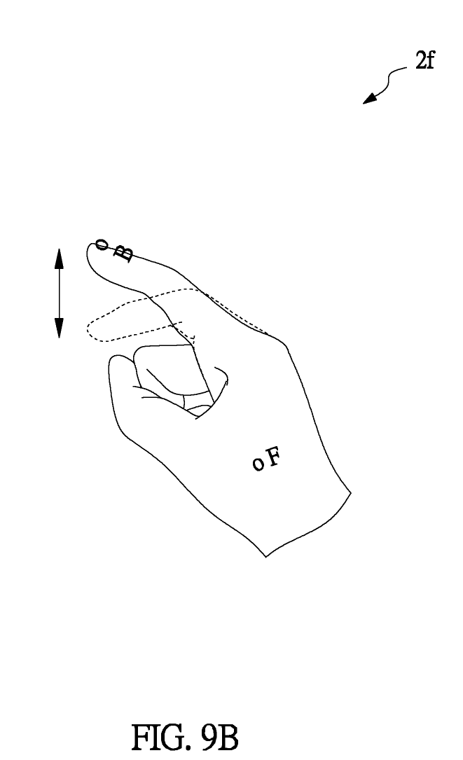

Finally, please refer to FIG. 9A and FIG. 9B. FIG. 9A is a flowchart of the gesture control method of the present application according to a sixth embodiment. FIG. 9B is a schematic drawing of the hand image of the fifth embodiment of the present application according to FIG. 9A.

After step 400 is executed, if the main control module 50 determines that the six identification points are not identified at the same time from the hand image 2 captured continuously by capture module 20, step 901 may also then be executed: identifying the second identification point and the sixth identification point.

In the sixth embodiment of the present application, if the six identification points are not identified at the same time from the hand image 2d by the main control module, the main control module 50 may identify the second identification point B and the sixth identification point F from the hand image 2d.

Step 902 is then executed: determining whether a moving distance of the second identification point is greater than a tenth specific distance.

The main control module 50 may determine that the moving distance of the second identification point is greater than a tenth specific distance.

If the answers to the abovementioned steps 901 to 902 are “YES”, step 903 is executed: executing an eighth command.

After the abovementioned steps are executed, the main control module 50 identifies the gesture of the hand image 2c. Thus, the eighth command is executed to control the controlled module 1a. In the sixth embodiment of the present application, the controlled module 1a may be a camera module, and the eighth command may be a command for capturing an image.

It should be noted that the gesture control method is not limited to the abovementioned sequences. As long as the purpose of the present application may be achieved, the abovementioned sequences of the steps may be changed.

Through the abovementioned procedures and the gesture control module 10, when using the wearable device 1, a user may use different hand images 2a, 2b, 2c, 2d, 2e or 2f conveniently to control different controlled modules 1a so as to decrease the occurrence of errors, providing an obvious improvement over the control method of the prior art.

Although the present application has been explained in relation to its preferred embodiments, it is to be understood that many other possible modifications and variations can be made without departing from the spirit and scope of the application as hereinafter claimed.

What is claimed is:

1. A gesture control method for a gesture control module comprising the following steps:
executing a setting procedure, comprising:
capturing a hand image;
identifying a plurality of identification points from the hand image; and
recording at least one relative distance between each identification point and other identification points; and
executing a controlling procedure, comprising:
determining whether a quantity of the identification points or their relative distances have changed; and
if yes, generating a corresponding command according to the changes in the quantity of the identification points or their relative distances.

2. The gesture control method as claimed in claim 1, wherein the step of executing the setting procedure further comprises:
identifying five fingertips and a palm center point as six identification points.

3. The gesture control method as claimed in claim 2, wherein the step of executing the setting procedure further comprises:
setting the five fingertips as a first identification point, a second identification point, a third identification point, a fourth identification point, and a fifth identification point sequentially, and
setting the palm center point as a sixth identification point.

4. The gesture control method as claimed in claim 3, wherein the step of executing the setting procedure further comprises:
determining whether the six identification points are identified at the same time.

5. The gesture control method as claimed in claim 4, wherein if the six identification points are identified at the same time, the following steps are executed:
determining that the relative distances between the third identification point, the fourth identification point, and the fifth identification point are longer than a first specific distance;
determining that the relative distance between the first identification point and the second identification point is shorter than a second specific distance; and
executing a first command.

6. The gesture control method as claimed in claim 4, wherein if the six identification points are identified at the same time, the following steps are executed: determining whether the relative distances between the first identification point, the second identification point, the third identification point, the fourth identification point and the fifth identification point are shorter than a third specific distance;
if yes, determining whether the relative distances from the first identification point, the second identification point, the third identification point, the fourth identification point, and the fifth identification point to the sixth identification point are longer than a fourth specific distance;
identifying when the first identification point, the second identification point, the third identification point, the fourth identification point, and the fifth identification point are rotating in a clockwise direction, and executing a second command; and
identifying when the first identification point, the second identification point, the third identification point, the fourth identification point, and the fifth identification point are rotating in a counterclockwise direction, and executing a third command.

7. The gesture control method as claimed in claim 6, wherein when the relative distances between the first identification point, the second identification point, the third identification point, the fourth identification point and the fifth identification point are longer than the third specific distance, the following steps are executed:
determining whether the relative distances from the first identification point, the second identification point, the third identification point, the fourth identification point, and the fifth identification point to the sixth identification point are longer than a fifth specific distance;
determining whether the relative distances between the second identification point, the third identification point, the fourth identification point, and the fifth identification point are shorter than a sixth specific distance; and determining whether the relative distance between the first identification point and the second identification point is longer than a seventh specific distance;
identifying when the first identification point, the second identification point, the third identification point, the fourth identification point, and the fifth identification point are rotating in a clockwise direction, and executing a fourth command; and
identifying when the first identification point, the second identification point, the third identification point, the fourth identification point, and the fifth identification point are rotating in a counterclockwise direction, and executing a fifth command.

8. The gesture control method as claimed in claim 4, wherein if the six identification points are not identified at the same time, the following steps are executed:
identifying the first identification point, the second identification point, the fifth identification point, and the sixth identification point;
determining whether the relative distances between the first identification point, the second identification point, and the fifth identification point are longer than an eighth specific distance; and
executing a sixth command.

9. The gesture control method as claimed in claim 4, wherein if the six identification points are not identified at the same time, the following steps are executed:
identifying the first identification point, the fifth identification point, and the sixth identification point;
determining whether the relative distance between the first identification point and the fifth identification point is longer than a ninth specific distance; and
executing a seventh command.

10. The gesture control method as claimed in claim 4, wherein if the six identification points are not identified at the same time, the following steps are executed:
identifying the second identification point and the sixth identification point;
determining whether a moving distance of the second identification point is longer than a tenth specific distance; and
executing an eighth command.

11. A gesture control module used for a wearable device, comprising:
a capture module, used for capturing a hand image;
an identification module, electrically connected to the capture module, for identifying a plurality of identification points from the hand and recording at least one relative distance between each identification point and other identification points in the image;
a database, electrically connected to the identification module and having a correspondence table for storing a plurality of hand image parameters and a plurality of corresponding command, wherein the plurality of hand image parameters comprises a change in a quantity of the identification points and their relative distances; and
a main control module, electrically connected to the identification module, for determining whether the quantity of the identification points or their relative distances have changed, and if the quantity of the identification points or their relative distances have changed, the main control module generates a corresponding command according to the changes in the quantity of the identification points or their relative distances according to a search of the correspondence table.

12. The gesture control module as claimed in claim 11, wherein the identification module is used for identifying five fingertips and a palm center point as six identification points.

13. The gesture control module as claimed in claim 12, wherein the identification module is used for setting the five fingertips as a first identification point, a second identification point, a third identification point, a fourth identification point, and a fifth identification point sequentially and setting the palm center point as a sixth identification point.

14. The gesture control module as claimed in claim 13, wherein the main control module is used for determining whether the six identification points are identified at the same time.

15. The gesture control module as claimed in claim 10, wherein the capture module is a depth sensor.

16. A wearable device, comprising:
a gesture control module, comprising:
a capture module, used for capturing a hand image;
an identification module, electrically connected to the capture module, for identifying a plurality of identification points from the hand and recording at least one relative distance between each identification point and other identification points in the image;
a database, electrically connected to the identification module and having a correspondence table for storing a plurality of hand image parameters and a plurality of corresponding command, wherein the plurality of hand image parameters comprises a change in a quantity of the identification points and their relative distances; and
a main control module, electrically connected to the identification module, for determining whether the quantity of the identification points or their relative distances have changed, and if the quantity of the identification points or their relative distances have changed, the main control module generates a corresponding command according to the changes in the quantity of the identification points or their relative distances according to a search of the correspondence table; and
a controlled module electrically connected to the main control module, used for executing a corresponding action according to the corresponding command.

17. The wearable device as claimed in claim 16, wherein the identification module is used for identifying five fingertips and a palm center point as six identification points.

18. The wearable device as claimed in claim 17, wherein the identification module is used for setting the five fingertips as a first identification point, a second identification point, a third identification point, a fourth identification point, and a fifth identification point sequentially and setting the palm center point as a sixth identification point.
